(19) United States
(12) Patent Application Publication
(10) Pub. No.: US 2012/0019586 A1
(43) Pub. Date: Jan. 26, 2012

(54) AUTOMATIC PRINTING OUTPUT INSPECTION DEVICE FOR OPTIC DISC AND PRINTER AND DISC WRITER INCORPORATING SAME

(75) Inventors: Mao Huai Weng, Taipei Hsien (TW); Hsia Pin Liao, Taipei Hsien (TW)

(73) Assignee: ACARD Technology Corp., Taipei Hsien (TW)

(21) Appl. No.: 12/963,912

(22) Filed: Dec. 9, 2010

(30) Foreign Application Priority Data
Jul. 23, 2010 (TW) 099214145

(51) Int. Cl. B41J 29/393

(52) U.S. Cl. 347/19

(57) ABSTRACT

Disclosed are an automatic printing output inspection device for optic disc and a printer and a disc writer incorporating the device. The automatic inspection device includes an image taking unit that takes an image of printing output of an optic disc, which is then processed by an image processing unit and compared by a comparison and identification unit with an original source of patterns to determine printing quality of the image. When it is determined that the printing quality does not match the original source, an alarm and feed-back unit is actuated to issue alarm notification for facilitating subsequent handling. Through the automatic inspection, printing quality of an optic disc can be efficiently inspected and products with poor printing can be identified for timely notification that helps saving waste of material, improving efficiency of printing output of optic disc, and saving human labor and time for inspection.

### BACKGROUND OF THE INVENTION

1. Field of the Invention

The present invention is related to an automatic printing output inspection device for optic disc, and more particular to an inspection device that automatically inspect printing quality of an optic disc.

2. Description of Related Art

A stand-alone disc writing device is often composed of a host controller and a plurality of disc writer or burner. When an optic disc is completely written, a separate printer is often used to print patterns or data is on a surface of the optic disc; or alternatively, patterns/data that are printed in advance must be stuck to the optic disc through manual operation, both being time- and labor-consuming. An optic disc writer device is disclosed by one of the inventors of the current application in Taiwan Utility Model Application No. 099211437 to solve such a problem. The device of the Utility Model comprises an embedded arrangement of a combination of a host controller, a disc writer assembly, and a printer assembly, in which a robotic arm is employed to pick up and deposit an optic disc from and to a disc deposition zone for performance of disc writing and to move a writing-completed disc into the printer assembly to allow the printer assembly to print patterns on a surface of the writing-completed disc, so that an advantage of completing writing and printing in an integrated process is realized.

However, the quality of the printing operation of an optic disc is affected by malfunctioning of the printer assembly or improper clamping of an optic disc, or undesired positional shift of an optic disc placed in the printer assembly, so as to result in poor printing quality, or even skewed printing, incorrect printing, or undesired color deviation. It is thus desired to provide means that prevent the occurrence of mistaken operations in printing, in a large batch fashion, writing-completed optic discs and means for notification, so as to improve the quality and efficiency of printing of optic discs and to eliminate unnecessary waste of material occurring in the process of printing optic discs.

### SUMMARY OF THE INVENTION

Accordingly, the primary objective of the present invention is to is provide an automatic printing output inspection device and a printer and a disc writer incorporating the device, wherein an image taking unit is employed to pick an image of optic disc printing, and processing and comparison of the image are then performed to identify quality of the printing, whereby when the printing quality is determined to be poor, an alarm and feed-back unit issues an alarm to facilitate subsequent handling. With the automatic and real time inspection operation, printing quality of an optic disc can be efficiently inspected and an optic disc with poor printing can be identified, so as to realize the advantage of saving labor and time for performing manual inspection and to ensure well control of printing quality.

To achieve the forgoing objective, according to the present invention, an automatic printing output inspection device for optic disc comprises:

an image taking unit, which takes an image of patterns/data printed on an optic disc;

an image processing unit, which is connected to the image taking unit and performs analysis processing on the image taken by the image taking unit; and

a comparison and identification unit, which is connected to the image processing unit and performs comparison of an image processed by the image processing unit and an original source of patterns to determine printing quality of the image.

The present invention further comprises an alarm and feed-back unit, which is connected to the comparison and identification unit, whereby when poor printing quality occurs, the comparison and identification unit generates a signal to have the alarm and feed-back unit issuing alarm notification so as to facilitate subsequent handling.

Another objective of the present invention is to provide a printer incorporating an automatic printing output inspection device for optic disc, comprising:

a disc printing unit, which prints image data to a surface of an optic disc;

an image taking unit, which takes an image of patterns/data printed on the optic disc by the disc printing unit;

an image processing unit, which is connected to the image taking unit and performs analysis processing on the image taken by the image taking unit;

a comparison and identification unit, which is connected to the image processing unit and performs comparison of an image processed by the image processing unit and an original source of patterns to determine printing quality of the image; and

an automatic controller unit, which receives a poor-printing signal issued from the comparison and identification unit and drives a robotic arm to pick up and move an optic disc with poor printing to a disc deposition zone.

The disc printer according to the present invention further comprises an alarm and feed-back unit, which is connected to the comparison and identification unit, whereby when poor printing quality occurs, the comparison and identification unit generates a signal to have the alarm and feed-back unit issuing alarm notification so as to facilitate subsequent handling.

A further objective of the present invention is to provide a disc writer incorporating an automatic printing output inspection device for optic disc, comprising:

a disc writing assembly, which writes data to an optic disc;

an automatic controller unit, which comprises a robotic arm and a disc deposition zone, and employs the robotic arm to pick up and deposit an optic disc from and to the disc deposition zone;

a disc printing unit, which prints image data to a surface of an optic disc; and

an automatic inspection device, which comprises an image taking unit, which takes an image of patterns/data printed on the optic disc; an image processing unit, which is connected to the image taking unit and performs analysis processing on the image take; a comparison and identification unit, which is connected to the image processing unit and performs comparison of an image processed by the image processing unit and an original source of patterns to determine printing quality of the image.

The disc writer according to the present invention further comprises an alarm and feed-back unit, which is connected to the comparison and identification unit, whereby when poor printing quality occurs, the comparison and identification unit generates a signal to have the alarm and feed-back unit issuing alarm notification so as to facilitate subsequent handling.

### BRIEF DESCRIPTION OF THE DRAWINGS

The present invention can be fully understood from the following detailed description and preferred embodiments with reference to the accompanying drawings, in which:

FIG. 1 is a block diagram of a preferred embodiment of the present invention;

FIG. 2 is a perspective view of a disc writer that incorporates an automatic inspection device according to the present invention; and

FIG. 3 is a side elevational view of a disc writer that incorporates an automatic inspection device according to the present invention.

### DETAILED DESCRIPTION OF THE PREFERRED EMBODIMENTS

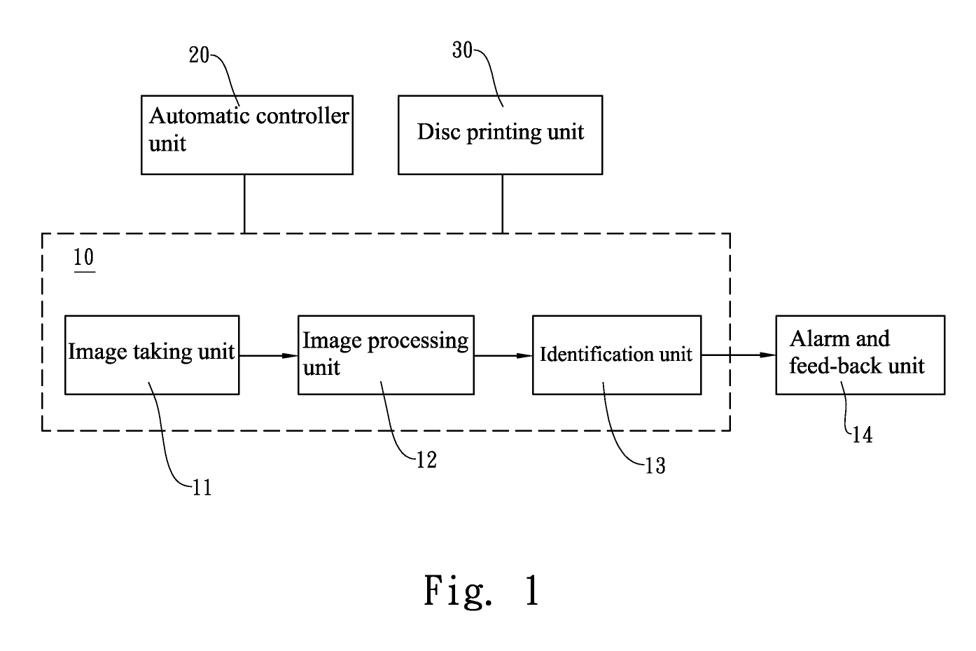

Reference is now made to FIG. 1, which is a block diagram of a preferred embodiment of the present invention. An automatic printing output inspection device 10 is provided according to the present invention for optics and comprises an image taking unit 11, an image processing unit 12, and a comparison and identification unit 13. The image taking unit 11 functions to pick up an image or data printed on an optic disc and may comprise for example a camera that takes an image of patterns or data printed on an optic disc and transmits the image to the image processing unit 12. The image processing unit 12 is connected to the image taking unit 11 and functions to carry out analysis processing on the image taken by the image taking unit 11. The image processing unit 12 performs analysis processing of the image through image processing software. The comparison and identification unit 13 is connected to the image processing unit 12, and the comparison and identification unit 13 may comprise an artificial intelligence unit, which compares the image processed by the image processing unit 12 with an original source of the pattern to determine the printing quality of the image and identify if any undesired printing flaw, such as color deviation, incorrect printing, or skewed printing, occurs.

The present invention further comprises an alarm and feed-back unit 14, which is connected to the comparison and identification unit 13. The comparison and identification unit 13, when identifying an occurrence of poor printing quality, generates a signal to have the alarm and feed-back unit 14 issue an alarm notification to facilitate subsequent handling. The alarm notification can be sound or light or even an e-mail or a short message for notifying a monitoring end. The alarm and feed-back unit 14 can alternatively be for example a wireless transmitter, which transmits a message of occurrence of poor printing quality to the monitoring end in a wireless manner for facilitating subsequent handling.

A printer system that incorporates the automatic inspection device 10 according to the present invention may further comprise an automatic controller unit 20 and a disc printing unit 30. The automatic controller unit 20 comprises a robotic arm and a disc deposition zone (not shown). The disc deposition zone may comprise a disc-to-be-printed area, a printing-completed disc area, and a poor-printing disc area. The automatic controller unit 20 controls the robotic arm to automatically pick up an optic disc for the performance of disc surface printing and also functions to detect any flaw operation of for example improper disc clamping, disc sticking, and fault clamping. The automatic controller unit 20 receives a poor-printing signal issued by the automatic inspection device 10 and in turn drives the robotic arm to pick up and move the poor-printing disc to the poor-printing disc area. The disc printing unit 30 functions to print image data to a surface of an optic disc. Once the printing is completed, the automatic inspection device 10 performs a comparison operation to determine if the printing is successful or the printing is poor. Thus, through the automatic processing operation carried out by the automatic inspection device 10, the quality of printing on an optic disc can be efficiently inspected and products with poor printing can be readily identified so as to save labor and time used for manual inspection and to ensure well control of printing quality.

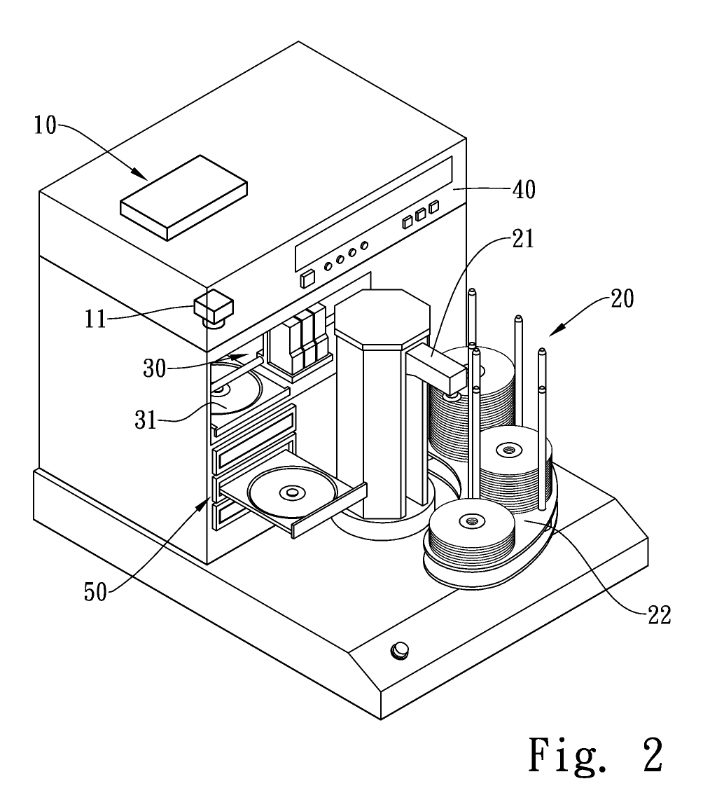

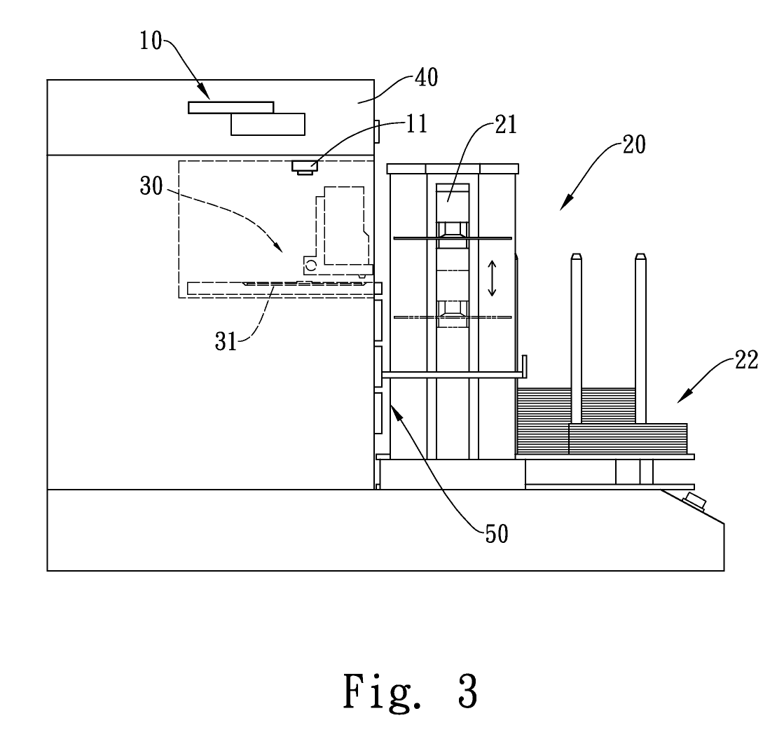

Reference is now made to FIGS. 2 and 3, which are respective a perspective view and a side elevational view of a disc writer that incorporates the automatic inspection device according to the present invention. The automatic printing inspection device for optic disc discussed above can be incorporated in a stand-alone disc writer, which comprises a control panel 40, a disc writing assembly 50, an automatic controller unit 20, a disc printing unit 30, and an automatic inspection device 10. The control panel 40 comprises operation interfaces, such as pushbuttons and a display screen. The disc writing assembly 50 comprises at least one disc writer, which functions to write data to an optic disc. The automatic controller unit 20 comprises a robotic arm 21 and a disc deposition zone 22. The disc deposition zone 22 comprises various disc areas for different purposes, including for example a disc-to-be-written area, a writing-completed disc area, and writing-failed disc area. The disc printing unit 30 functions to print image data on a surface of a writing-completed optic disc and comprises a disc tray 31 into which an optic disc may be loaded. The automatic inspection device 10, similar to what discussed above, comprises an image taking unit 11, which can be for example mounted above the disc tray 31 to take image of printing on the optic disc for comparison and identification.

When the disc writing assembly 50 completes a writing operation on an optic disc, the automatic controller unit 20 drives the robotic arm 21 to automatically pick up and moves the optic disc to the disc printing unit 30 performance of surface printing of the optic disc and also to detect any flaw operation of for example improper disc clamping, disc sticking, and fault clamping. Once the printing of the optic disc is completed, the quality of printing is acceptable or poor can be automatically identified through the operations of image taking, process, comparison, and determination made by the automatic inspection device 10. When the printing quality is poor, the automatic controller unit 20 receives a poor-printing signal issued by the automatic inspection device 10 and in turn drives the robotic arm 21 to pick up and move the poor-printing disc to the poor-printing disc area and an alarm notification is issued through the alarm and feed-back unit 14.

With the above described arrangement, the present invention realizes automatic inspection that allows for saving of human labor and time in making manual inspection, thereby realizing efficient inspection of printing quality of optic disc and identification of products with poor printing quality. As such, the objective of the present invention can be achieved.

What is claimed is:

1. An automatic printing output inspection device for optic disc, comprising:
an image taking unit, which takes an image of patterns/data printed on an optic disc;
an image processing unit, which is connected to the image taking unit and performs analysis processing on the image taken by the image taking unit; and
a comparison and identification unit, which is connected to the image processing unit and performs comparison of an image processed by the image processing unit and an original source of patterns to determine printing quality of the image.

2. The automatic printing output inspection device according to claim 1, wherein the image taking unit comprises a camera.

3. The automatic printing output inspection device according to claim 1, wherein the comparison and identification unit identifies a printing flaw of color deviation, skewed printing, and incorrect printing of printed image data.

4. The automatic printing output inspection device according to claim 1 further comprising an alarm and feed-back unit, which is connected to the comparison and identification unit, whereby when poor printing quality occurs, the comparison and identification unit generates a signal to have the alarm and feed-back unit issuing alarm notification.

5. The automatic printing output inspection device according to claim 4, wherein the alarm notification issued by the alarm and feed-back unit comprises sound or light.

6. The automatic printing output inspection device according to claim 4, wherein the alarm and feed-back unit issues the alarm notification through an e-mail or a short message.

7. The automatic printing output inspection device according to claim 4, wherein the alarm and feed-back unit comprises a wireless transmitter, which transmit occurrence of poor printing quality to a monitoring end through wireless transmission.

8. A printer incorporating an automatic printing output inspection device for optic disc, comprising:
a disc printing unit, which prints image data to a surface of an optic disc;
an image taking unit, which takes an image of patterns/data printed on the optic disc by the disc printing unit;
an image processing unit, which is connected to the image taking unit and performs analysis processing on the image taken by the image taking unit;
a comparison and identification unit, which is connected to the image processing unit and performs comparison of an image processed by the image processing unit and an original source of patterns to determine printing quality of the image; and
an automatic controller unit, which receives a poor-printing signal issued from the comparison and identification unit and drives a robotic arm to pick up and move an optic disc with poor printing to a disc deposition zone.

9. The printer according to claim 8, wherein the image taking unit comprises a camera.

10. The printer according to claim 8, wherein the comparison and identification unit identifies a printing flaw of color deviation, skewed printing, and incorrect printing of printed image data.

11. The printer according to claim 8, wherein the automatic controller unit detects flaw operation of improper disc clamping, disc sticking, and fault clamping.

12. The printer according to claim 8 further comprising an alarm and feed-back unit, which is connected to the comparison and identification unit, whereby when poor printing quality occurs, the comparison and identification unit generates a signal to have the alarm and feed-back unit issuing alarm notification.

13. A disc writer incorporating an automatic printing output inspection device for optic disc, comprising:
a disc writing assembly, which writes data to an optic disc;
an automatic controller unit, which comprises a robotic arm and a disc deposition zone, and employs the robotic arm to pick up and deposit an optic disc from and to the disc deposition zone;
a disc printing unit, which prints image data to a surface of an optic disc; and
an automatic inspection device, which comprises an image taking unit, which takes an image of patterns/data printed on the optic disc; an image processing unit, which is connected to the image taking unit and performs analysis processing on the image take; a comparison and identification unit, which is connected to the image processing unit and performs comparison of an image processed by the image processing unit and an original source of patterns to determine printing quality of the image.

14. The disc writer according to claim 13 further comprising an alarm and feed-back unit, which is connected to the comparison and identification unit, whereby when poor printing quality occurs, the comparison and identification unit generates a signal to have the alarm and feed-back unit issuing alarm notification.

15. The disc writer according to claim 13, wherein the automatic controller unit receives a poor-printing signal issued from the comparison and identification unit and drives the robotic arm to pick up and move an optic disc with poor printing to the disc deposition zone.

16. The disc writer according to claim 13, wherein the image taking unit comprises a camera and the disc printing unit comprises a disc tray into which an optic disc is loadable, the image taking unit being arranged above the disc tray.
